(19) United States
(12) Patent Application Publication
(10) Pub. No.: US 2026/0369980 A1
(43) Pub. Date: Nov. 19, 2026

(54) WIRE ROUTING SYSTEM

(71) Applicant: Steelcase Inc., Grand Rapids, MI (US)

(72) Inventors: David Eberlein, Hudsonville, MI (US); Chad Thomas Goodman, Portland, MI (US); Karl J. Mead, Grand Rapids, MI (US)

(21) Appl. No.: 19/663,558

(22) Filed: Apr. 30, 2026

Related U.S. Application Data
(60) Provisional application No. 63/802,114, filed on May 8, 2025.

(51) Int. Cl. H02G 3/36; H02G 1/08

(52) U.S. Cl. CPC H02G 3/36; H02G 1/08

(57) ABSTRACT

A wire routing system that includes a plurality of housings each having a raceway extending therethrough, the plurality of housings including an end housing and a middle housing, a continuous, unbroken wire extending through the raceway of each of the housings of the plurality of housings, wherein the middle housing includes a connector configured to connect the wire to the middle housing thereby preventing the middle housing from sliding along a length of the wire and electrically grounding the middle housing to the wire, wherein the end housing is slidable along the length of the wire and has an end configured to be cut to a predetermined length, and at least one connector plate positioned between the middle housing and the end housing and configured to electrically ground the end housing to the wire via the middle housing.

### CROSS-REFERENCE TO RELATED APPLICATIONS

This application claims benefit to U.S. Provisional Patent Application No. 63/802,114, entitled “WIRE ROUTING SYSTEM,” filed on May 8, 2025, the entire contents of which is incorporated herein by reference in its entirety.

### BACKGROUND OF THE DISCLOSURE

Current wire routing systems, and in particular floor power distribution systems are often difficult to assemble and conceal. Most systems are constructed on-site from individual components requiring significant installation time and potentially specialized tools and assembly equipment, while other systems require significant customization at the manufacturing facility prior to shipment to the install site. Thus, there is a need for a wire routing system that may be utilized beneath floor coverings that overcomes these deficiencies.

### SUMMARY OF THE DISCLOSURE

One aspect as shown and described herein includes a wire routing system that includes a plurality of housings each having a raceway extending therethrough, the plurality of housings including an end housing and a middle housing, a continuous, unbroken wire extending through the raceway of each of the housings of the plurality of housings, wherein the middle housing includes a connector configured to connect the wire to the middle housing thereby preventing the middle housing from sliding along a length of the wire and electrically grounding the middle housing to the wire, wherein the end housing is slidable along the length of the wire and has an end configured to be cut to a predetermined length, and at least one connector plate positioned between the middle housing and the end housing and configured to electrically ground the end housing to the wire via the middle housing.

Another aspect as shown and described herein may further or alternatively include a method for installing a wire routing system that includes providing a wire routing system that includes at least three interconnected housings including a middle housing, an end housing and an additional housing, each housing of the at least three housings including a raceway, routing a wire through the raceway of each housing of the at least three interconnected housings, fastening the wire to the middle housing thereby preventing the middle housing from sliding along a length of the wire, wherein the end housing is slidable along the length of the wire securing the end housing and the additional housing to the middle housing via a plurality of connector plates thereby electrically grounding the end housing and the additional housing to the wire via the plurality of connector plates, and securing at least one of the housing to a structural component of the building.

Still another aspect as shown and described herein may further or alternatively include a wire routing system that includes a plurality of housings each including a first end, a second end opposite the first end, a raceway extending between the first and second ends, and a longitudinal axis, wherein the plurality of housings includes a first end housing, a second end housing and a middle housing positioned between the first and second end housings, an electrical wire extending within the raceway and from the first and second ends of each of the plurality of housings, wherein the middle housing is fixed along a length of the electrical wire, and wherein the longitudinal axis of the housings are repositionable with respect to one another, and a plurality of connector plates configured to secure pairings of adjacent housings of the plurality of housings to one another thereby preventing repositioning of the longitudinal axis of the housings with respect to one another.

These and other aspects, objects, and features of the present disclosure will be understood and appreciated by those skilled in the art upon studying the following specification, claims, and appended drawings.

### BRIEF DESCRIPTION OF THE DRAWINGS

FIG. 1A is a perspective view of a wire routing system;

FIG. 1B is a perspective view of an alternative embodiment of the wire routing system;

FIG. 2 is an enlarged perspective view of the area II, FIG. 1;

FIG. 3 is an exploded top perspective view of a housing or track member and a pair of associated ramps;

FIG. 3A is a perspective view of a grommet;

FIG. 3B is an end elevation view of the track member and the pair of associated ramps;

FIG. 4 is an exploded bottom perspective view of a housing or track member;

FIG. 5 is a perspective view of an in-line connector assembly connecting a pair of adjacent housings;

FIG. 6 is an exploded perspective view of the in-line connector assembly of FIG. 5;

FIG. 7 is a perspective view of a corner connector assembly attaching adjacent housings;

FIG. 8 is an exploded perspective view of the corner connector assembly of FIG. 7;

FIG. 9 is a perspective view of a building interface junction box;

FIG. 10 is a perspective view of a connection arrangement of the building interface junction box;

FIG. 11 is a perspective view of the wire routing system within a kit;

FIG. 12A is a perspective view of an end track member in a retracted position with a plurality of electrical wires extending from an end of the end track member;

FIG. 12B is a perspective view of the end track member in an extended position within the plurality of electrical wires retracted from the end of the track member;

FIG. 12C is a perspective view of a portable band saw positioned to cut the end of the track member;

FIG. 12D is a perspective view of the end track member in the retracted position with the plurality of electrical wire extending from a cut end of the track member;

FIG. 13 is a perspective view of an alternative embodiment of the wire routing system;

FIG. 14 is a perspective view of a configuration of the embodiment of FIG. 13;

FIG. 15A is a cross-sectional elevation view of a track member and ramps taken along the line XVA-XVA, FIG. 14;

FIG. 15B is a cross-sectional elevation view of a track member and ramps taken along the line XVB-XVB; FIG. 13;

FIG. 15C is a cross-sectional elevation view of a track member and ramps;

FIG. 15D is a cross-sectional elevation view of a track member and ramps taken along the line XVD-XVD, FIG. 13;

FIG. 16A is a bottom plan view of an inner corner ramp member;

FIG. 16B is a side elevation view of the inner corner ramp member;

FIG. 17A is a bottom plan view of an outer corner ramp member;

FIG. 17B is a side elevation view of the outer corner ramp member; and

FIG. 18 is a perspective view of an alternative embodiment of the wire routing system.

### DETAILED DESCRIPTION OF PREFERRED EMBODIMENTS

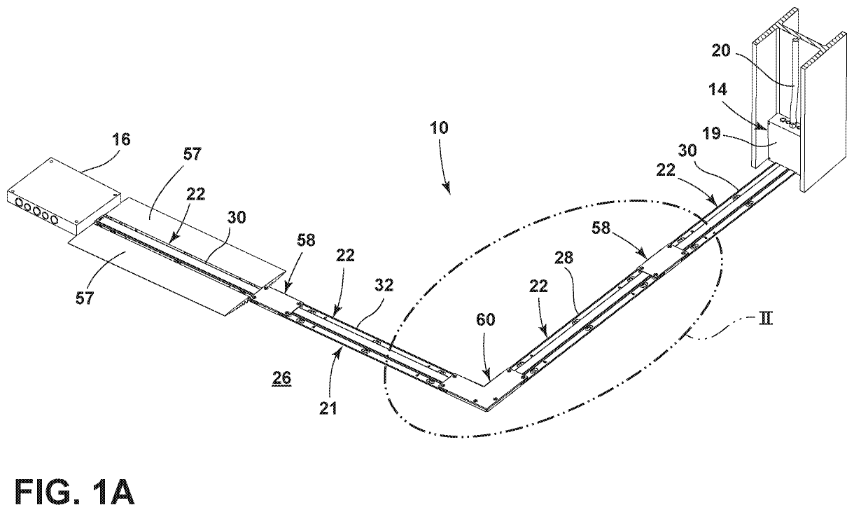

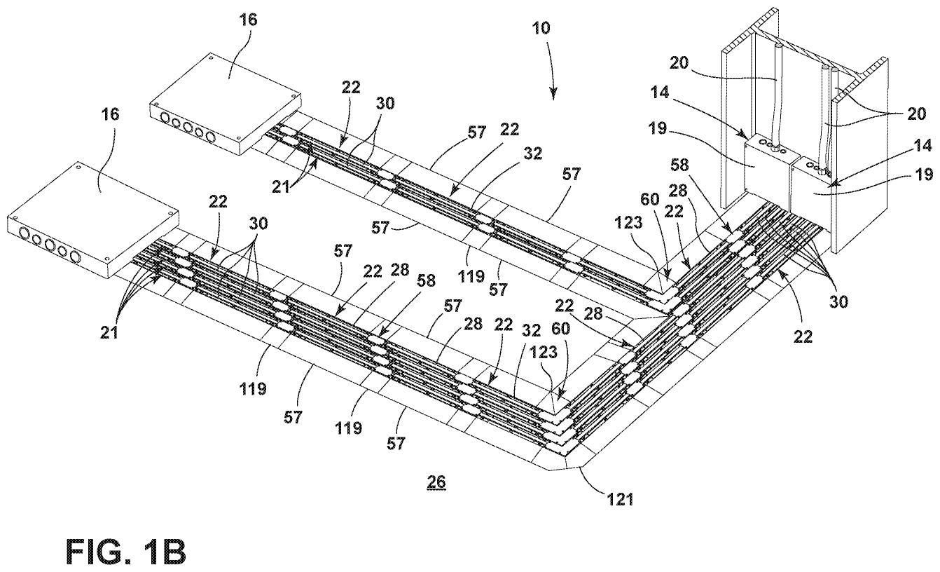

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items can be employed. For example, if an apparatus is described as containing components A, B, and/or C, the composition can contain A alone; B alone; C alone; A and B in combination; A and C in combination; B and C in combination; or A, B and C in combination.

The reference numeral 10 (FIG. 1A) generally designates a wire routing system, and in particular a wire routing system configured to be utilized as a floor power distribution system configured to provide routing of electrical and communication lines across a floor surface and beneath a floor covering such as a carpet. The system 10 benefits from a modular and low profile design that may be provided as a customized or semi-customized kit for implementation within commercial, educational and domestic settings. In the illustrated example, the wire routing system 10 is configured to route electrical and/or communication lines between a primary power source 14 and one or more junction boxes 16 used to convey power and/or communications to locations within an associated setting or area spaced from the primary power source 14. In the illustrated example, the primary power source 14 is located with within a wall structure 18 where the primary power source 14 includes a building interface junction box 19 connected to a power electrical line 20. While the illustrated example of the primary power source 14 includes a building interface junction box 19, other forms of the primary power source 14 may be utilized such as direct wiring, floor wiring, ceiling wiring, and the like. The junction boxes 16 are located within the overall setting or floor space to provide power to remotely positioned locations and to arrangements such as counters, displays, lighting arrangements, shelving units, storage assemblies, product placement displays, and the like.

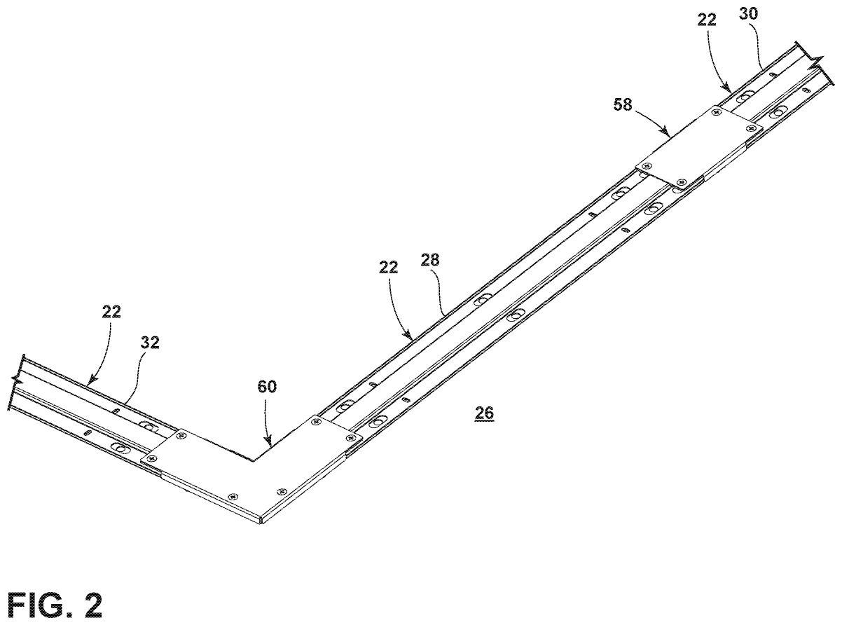

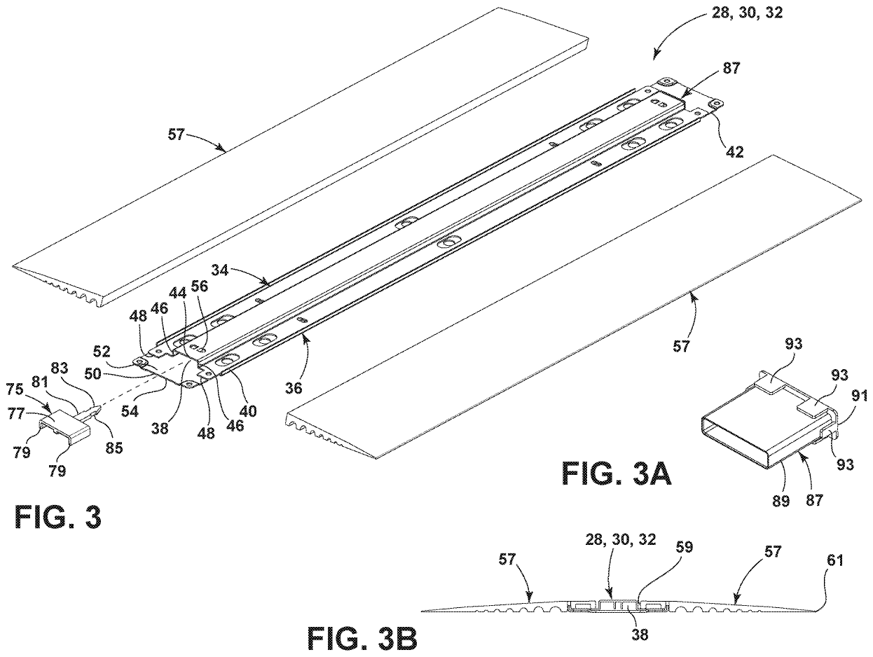

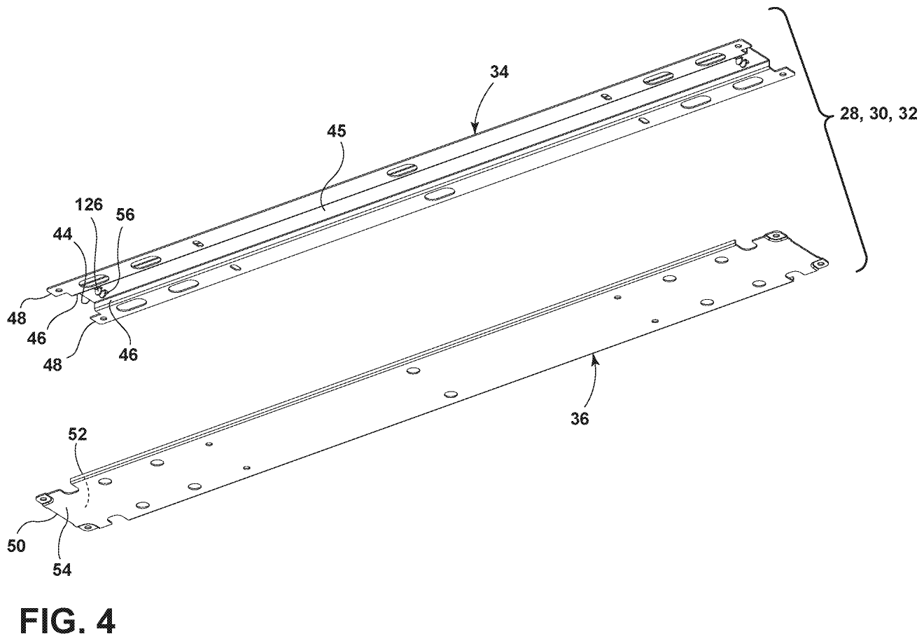

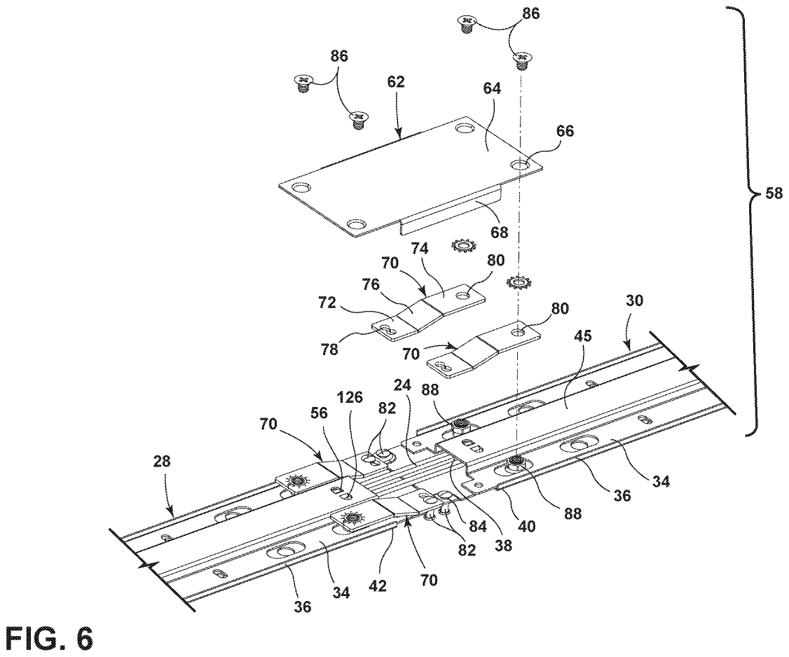

The wire routing system 10 further includes housing or tracking assemblies 21 comprising a plurality of housings 22 (FIGS. 1A and 2) coupled to one another and configured to route a plurality of electrical wires 24 (FIG. 6) therethrough. In the illustrated example, each housing 22 is provided in the form of an elongated track where each track is configured to be supported on an associated floor surface 26 and beneath an associated floor covering such as a carpet (not shown). Each housing is preferably comprised of an electrically conductive material such as steel. The wire routing system 10 as shown includes a middle housing or track 28, a pair of oppositely positioned end housings or tracks 30, and an additional housing or track 32 where multiple additional housings or tracks 32 may be utilized. Each track 28, 30, 32 (FIGS. 3 and 4) includes an upper portion 34 and a lower portion 36 that cooperate to define a raceway or wire routing channel 38 extending between a first end 40 and a second end 42 of the tracks 28, 30, 32. The upper portion 34 has a hat-shaped cross-sectional configuration and includes an upper wall 44 having an upper wall 45, a pair of side walls 46 extending orthogonally downward from the upper wall 44, and a pair of flanges 48 extending orthogonally outward from the side walls 46. The upper wall 44 of each of the tracks 28, 30, 32 may include a wire grounding arrangement 56 as further described below. The bottom wall 50 has a generally planar configuration and includes a bottom wall 50 having an upper surface 52 and a bottom surface 54 configured to abut the floor surface 26. The upper wall 44 and side walls 46 of the upper portion 34 cooperate with the bottom wall 50 of the lower portion 36 to define the longitudinally extending race way or wire routing channel 38.

The wire routing system 10 may further include grommets 75 located within the wire routing channel 38 at opposite ends of the associated track 28, 30, 32, where the grommets 75 are configured to protect the electrical wires 24 during assembly of the wire routing system 10, during installation, and during use of the area in which the system is installed. Each grommet 75 may include a rectangularly-shaped planar body portion 77, a pair of legs 79 extending orthogonally downward from the body portion 77 and configured to abut the upper surface 52 of the bottom wall 50 Of the lower portion 36 of the track 28, 30, 32 such that the body portion 77 is coplanar with the upper wall 44 of the upper portion 34 upon installation, and an engagement portion 81. In the illustrated example, the elongated engagement portion 61 includes an angled leading portion 83 and a pair of reliefs 85 located along the length of the engagement portion where the engagement portion 81 is configured to snappily engage the wire grounding engagement 56 or separate feature or element of the track 28, 30, 32. Alternatively, a grommet 87 (FIG. 3A) may include an elongated body 89 having a rectangularly-shaped cross-sectional configuration, a collar portion 91 extending about a peripheral end of the body 89, and a plurality of engagement tabs 93 spaced about the collar portion 91, where the body is received within the wire routing channel 38 and the tabs 93 frictionally engage the inner surfaces of the wire routing channel 38. Other grommet arrangements may utilize a combination of snapping and frictional engagement.

The wire routing system 10 may also include a plurality of ramp members 57 (FIGS. 1A, 3, 3B) disposed on opposite sides of the tracks 28, 30, 32 and extending the length thereof similar to those as described in U.S. Pat. No. 9,685,730 entitled floor Power System, the disclosure of which is incorporated herein by reference in its entirety. Each ramp 57 may have a height similar to the height of the tracks 28, 30, 32, and may be partially supported by the tracks 28, 30, 32 such that an underside of the ramp members 57 are coplanar with the bottom surface 54 of the lower portion 36 of the tracks 28, 30, 32. Each ramp 57 may taper when moving from an end 59 proximate the associated track 28, 30, 32 to an end 61 distal to the track 28, 30, 32 which enables the ramps 57 and tracks 28, 30, 32 to be less apparent when placed under a floor covering such as carpet. The ramps 57 may be secured to the tracks 28, 30, 32 via mechanical fasteners (not shown).

As best illustrated in FIG. 1A, the tracks 28, 30, 32 extend between the building interface junction 19 and one or more junction boxes 16 and are connected to one another via connector assemblies including in-line connector assemblies 58, and corner connector assemblies 60. While the corner connector assembly 60 is illustrated as connecting the adjacent tracks 28, 32 to one another such that the tracks 28, 32 extend orthogonally from one another, other configurations of the corner connector assemblies 60 may be utilized such that the tracks 28, 32 extend at other angles from one another.

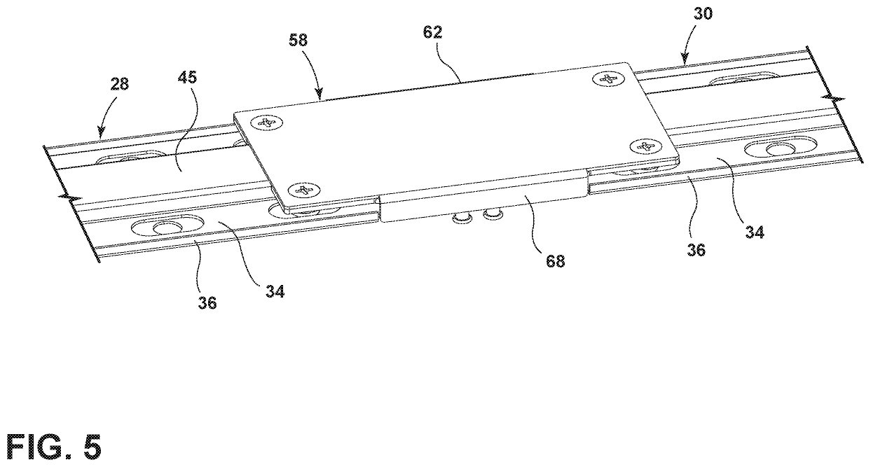

As best illustrated in FIGS. 5 and 6, each in-line connector assembly 58 includes a top connector plate 62 having a rectangularly-shaped planar body portion 64 with a plurality of screw-receiving apertures 66 extending therethrough, and a pair of flanges 68 located on opposite sides of the body portion 64 and extending orthogonally downward from the body portion 64. The in-line connector assembly 58 further includes a pair of Z-shaped intermediate connector plates 70 each having a first end 72, a second end 74, and a middle portion 76 extending angularly from and between the first end 72 and the second end 74. The first end 72 includes a fastener receiving aperture 78, while the second end includes a fastener receiving aperture 80. In assembly, the first end 72 of each of the intermediate connector brackets 70 are attached to a first end 40 or a second end 42 of the associated track 28, 30 via a mechanical fastener such as a rivet 82 that extends through the aperture 78 of the first end 72 of the intermediate connector brackets 70 and through a corresponding aperture 84 extending through the bottom wall 50 of the lower portion 36 of the track 28, 30. The top connector bracket 72 is connected to a pair of the intermediate connector plates 70 that are attached to the ends 40, 42 of the tracks 28, 30, 32 via a plurality of mechanical fasteners such as screws 86 that extend through the apertures 66 of the body portion 64 of the top connector plate 62 and through corresponding apertures 80 of the intermediate connector plates 70, where the screws 86 threadably couple with a corresponding nut 88.

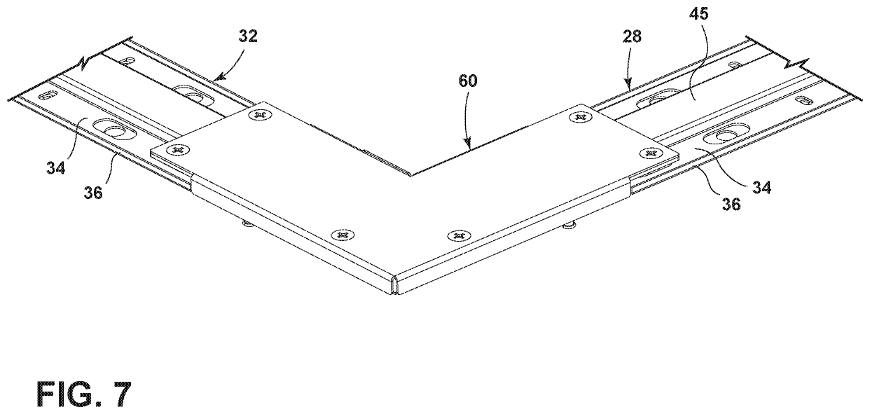

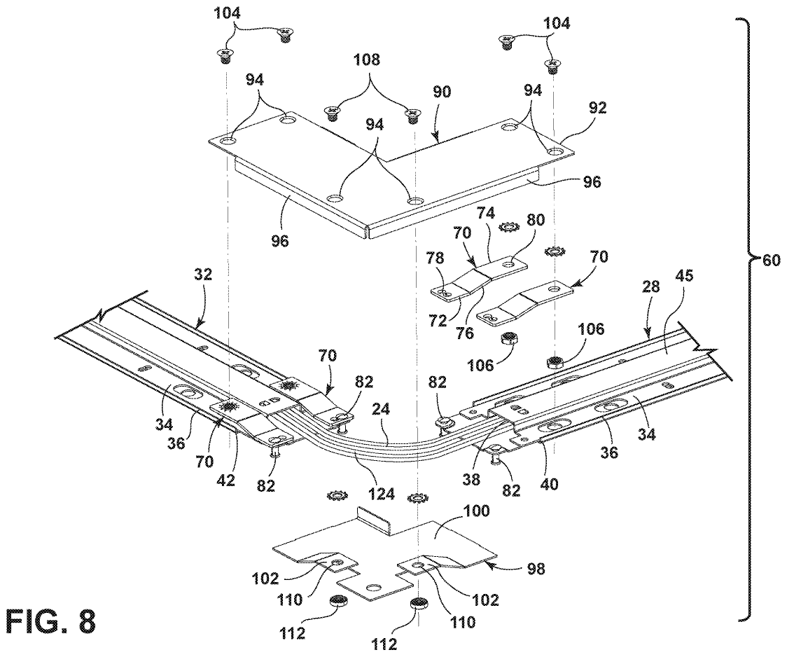

As best illustrated in FIGS. 7 and 8, each corner connector assembly 60 includes a top connector plate 90 having an L-shaped body portion 92 having a plurality of fastener receiving apertures 94 extending therethrough and flanges 96 located on opposite sides of the body portion 92 from one another and extending orthogonally downward from the body portion 92. The corner connector assembly 60 further includes pairs of the intermediate connector plates 70 connected to the respective ends 40, 42 of the tracks 28, 32 similar to as previously described. The corner connector assembly 60 further includes an L-shaped bottom connector bracket 98 having a body portion 100 that abuts the floor surface 26 and a pair of raised flanges 102 extending from the body portion 100.

In assembly, the intermediate connector plates 70 are connected to the ends 40, 42 of the tracks 28, 32 in a manner similar to that as previously described. The top connector plate 90 is connected to the intermediate connector plates 70 via a plurality of mechanical fasteners such as screws 104 extending through apertures 94 of the body portion 92 of the top connector plate 90 and the aperture 80 of the corresponding intermediate connector plates 70, and threadably coupled to corresponding nuts 106. The top connector bracket 90 is coupled to the bottom connector bracket 98 via mechanical fasteners such as screws 108 extending through apertures 94 of the body portion 92 of the top plate connector 90 and apertures 110 of the raised flanges 102 of the bottom connector plate 98 and threadably coupled with corresponding nuts 112.

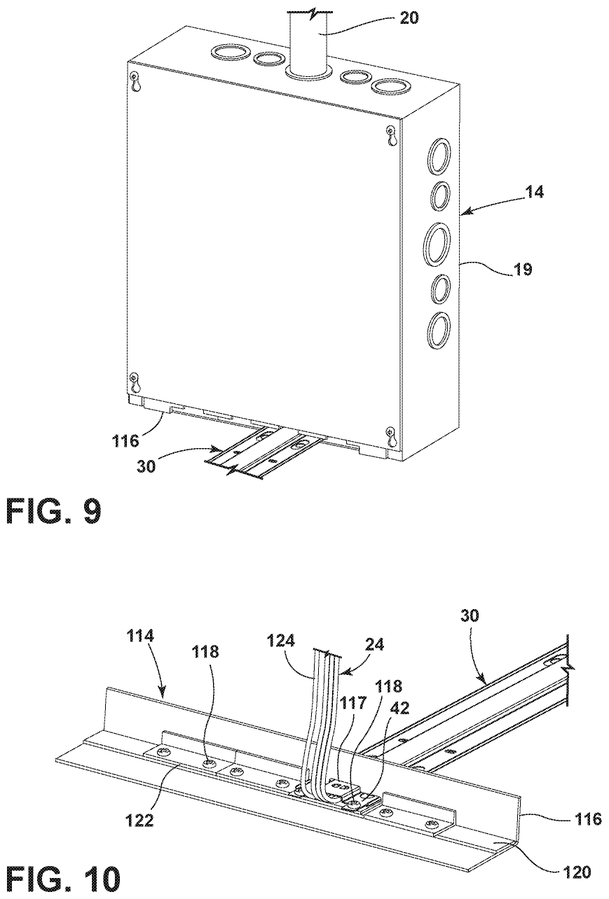

As best illustrated in FIGS. 9 and 10, the end housing or track 30 is connected to the building interface junction box 19 via an electrically-grounding connection arrangement 114. In the illustrated example, the connection arrangement 114 includes a coupling plate 116 located within an interior of and attached to the building interface junction box 19. The coupling plate 116 includes one or more hat-shaped apertures 117 that receive the second end 42 of a corresponding end housing or track 30. As illustrated, the coupling plate 116 may include a plurality of the apertures 117 so as to receive a plurality of the tracks 30 therein. L-shaped cover plates 122 may be secured over apertures 117 via screws 118 for those apertures 117 that do not receive a track 30. The second end 42 of the end housing or track 30 is secured to the coupling plate 116 via a plurality of mechanical fasteners such as screws 118. A grounding bar 120 may be provided so as to increase the electrical ground between the building interface junction box 19 and the end housing or track 30. A similar electrically-grounding connection arrangement may be utilized to connect the opposite end track 30 to the junction box 16.

As best illustrated in FIG. 1B, the various components and elements of the wire routing system 10 may be intermixed and combined to routed electrical and communication lines between multiple building interface junction boxes 19 and junction boxes 16 via multiple housing or track assemblies 21. Each track assembly 21 as shown in FIG. 1B includes a combination of various components and elements as previously described, including a plurality of the tracks 28, 30, 32, the in-line connector assemblies 58, the corner connector assemblies 60, and the ramp members 57. Each wire routing system may further include in-line spacing ramp members 119 interspaced between adjacent ramp members 57, outer corner ramp members 121, and inner corner ramp members 123, where the outer corner ramp members 121 and the inner corner ramp members 123 may each comprise multiple or single integral pieces. The in-line connector assemblies 58 may be laterally aligned with one another or offset from one another along the length of the associated track assemblies 21 as shown in FIG. 1B.

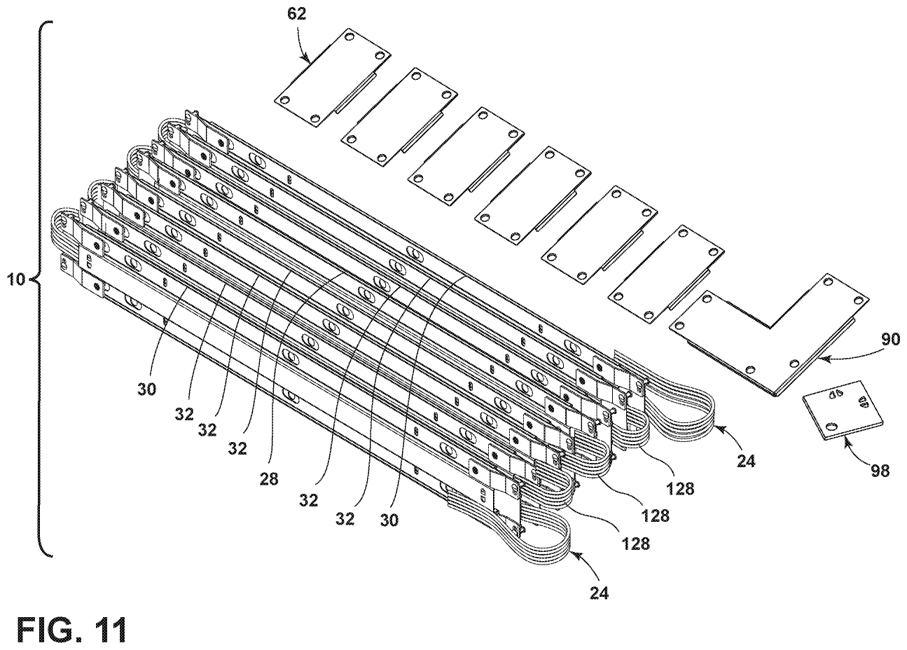

The wire routing system 10 (FIG. 11) may be provided as a kit, where a continuous, uninterrupted wire 24 is fed or passed through the race way or wire routing channel 38 of each of the tracks 28, 30, 32. While the example of the wire routing system 10 shown in FIG. 11 includes a total of eight tracks 28, 30, 32, a single or any number of tracks 28, 30,32 may be utilized depending on general layout and configuration required. Once the general layout and configuration of the wire routing system 10 is determined, a kit may be provided that includes a hardwired arrangement where the electrical wires 24 have been routed or fed through the race way or wire routing channels 38 of each of the tracks 28, 30, 32. A grounding wire 124 of the electrical wires 24 may be secured to and grounded to the middle housing or track 28 via the wire grounding arrangement 56 of the middle housing or track 28. In the illustrated example, the wire grounding arrangement 56 (FIGS. 3, 4 and 6) may include a pair of tabs 126 punched or formed from the upper wall 44 of the upper portion 34 of the middle housing or track 28. Alternatively, the grounding wire 124 may be grounded to the middle housing or track 28 via a separate mechanical fastener. In assembly, the grounding wire 124 is positioned between the tabs 126 and the tabs 126 are crimped about the grounding wire 124 thereby grounding the middle housing or track 28 to the grounding wire 124, and further preventing the middle housing or track 28 from sliding along the length of the electrical wires 24. Alternatively, multiple middle housings or tracks 28 may be secured to the grounding wire 124 via an associated wire grounding arrangement 56, although additional such connections may not be necessary. Grounding of the track or tracks 28 to the grounding wire 124 via the tabs 126 or in another manner may be completed at the manufacturing or assembly facility or on site at the point of installation. The kit of the wire routing system 10 is further configured to include loops 128 of the electrical wires 24 between the tracks 28, 30, 32 thereby allowing the wire routing system 10 to be laid out within the given area and then fastened to one another via the linear connector assemblies 58 and corner connector assemblies 60. In certain embodiments the track(s) 28 are not secured to the grounding wire 124 such that the tracks 28, 30, 32 remained slidable along the length of the wires 24. In such embodiments one or more of the tracks 28, 30, 32 may be grounded to the ground wire 124 via other paths, including for example, direct contact of ground wire 124 with the tracks 28, 30, 32.

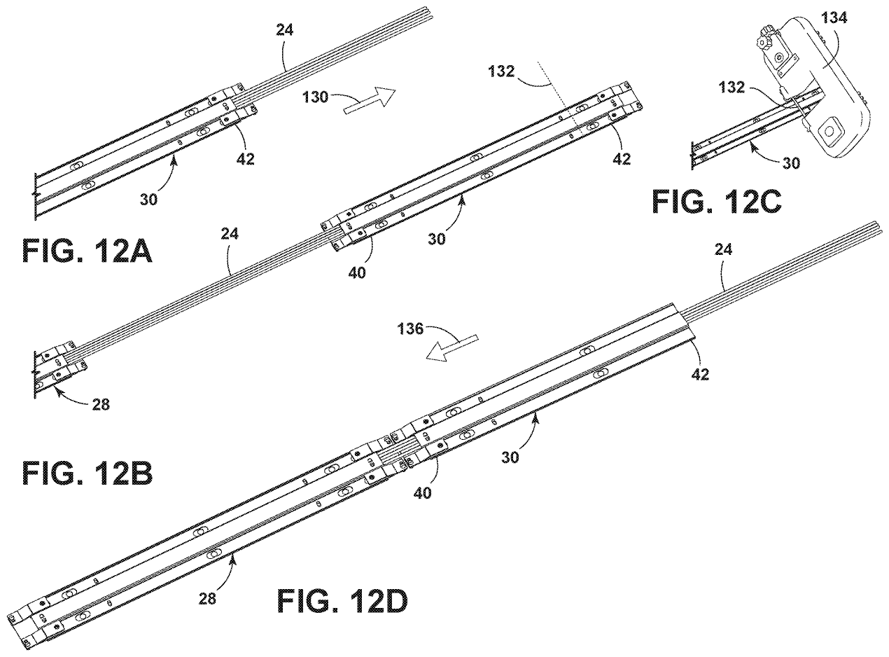

During installation, the overall length of the combined tracks 28, 30, 32 of the wire routing system may be adjusted by shortening or cutting at least one of the end housing or tracks 30. As best illustrated in FIGS. 12A-12D, the length of the end housing or track 30 may be adjusted by sliding one of the end tracks 30 in a first direction 130 from a retracted position (FIG. 12A) where the electrical wires 124 extend beyond the second end 42 of the end track 30 to an extended position (FIG. 12B) where the second end 42 of the end track 30 extends beyond a distal most end of the electrical wires 24. After determining the necessary length of the track 30, the end track 30 can be cut along a cut line 132. For on-site applications, a portable saw such as a portable band saw 134 may be utilized to cut the end track 30. The end track 30 is then slid along the length of the electrical wires 24 in a direction 136 from the extended position (FIG. 12B) to a retracted position (FIG. 12D) where the end track 30 can then be secured to the middle housing or track 28 via the in-line connector assembly 58 or the corner connector assembly 60 in the manner described above. The grommets 75, 87 are configured and positioned to protect the electrical wires 24 from being damaged as the tracks 28, 30, 32 are positioned or slid along the electrical wires 24.

The wire routing system 10 provides multiple paths for electrically grounding the various related components. In particular, the tracks 28, 30, 32 are each grounded to the primary power source 14, and in particular the building interface junction box 19 via at least two grounding paths. Each track 28, 30, 32 is grounded to one another via the in-line and/or corner 58, 60 and specifically the connector assemblies connector plates 62, 70, 90, 98 thereof. The end track 30 is correspondingly electrically grounded to the building interface junction box 19 via the electrically-grounding connection arrangement 114, while the junction box 16 is electrically grounded to the opposite end track 30 via a similarly configured electrically-grounding connection arrangement. The components are also electrically grounded via the wire grounding arrangement 56 as the tabs 126 are in contact with the electrical ground wire 124. The multiple grounding paths ensure proper grounding between the various components of the wire routing system 10.

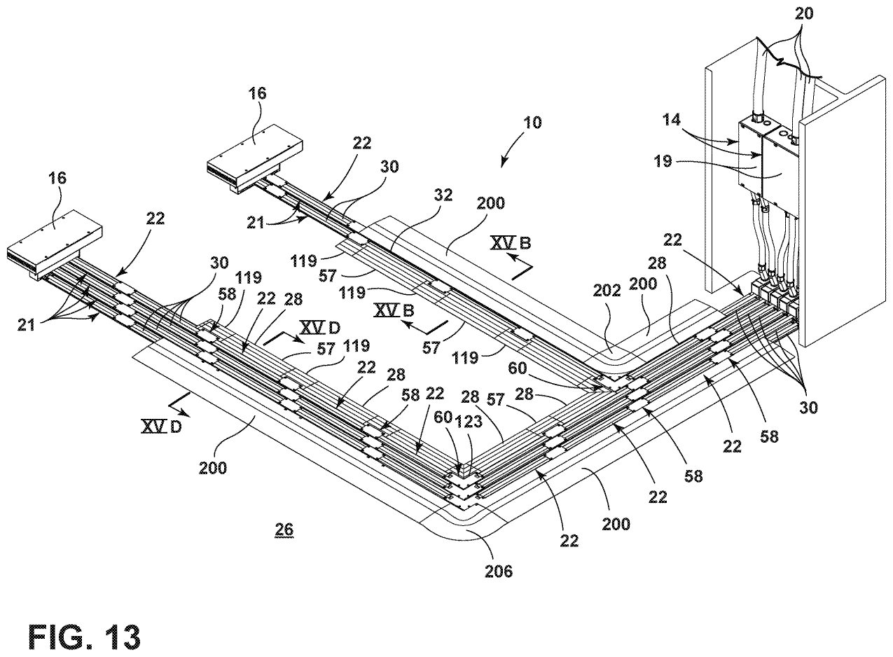

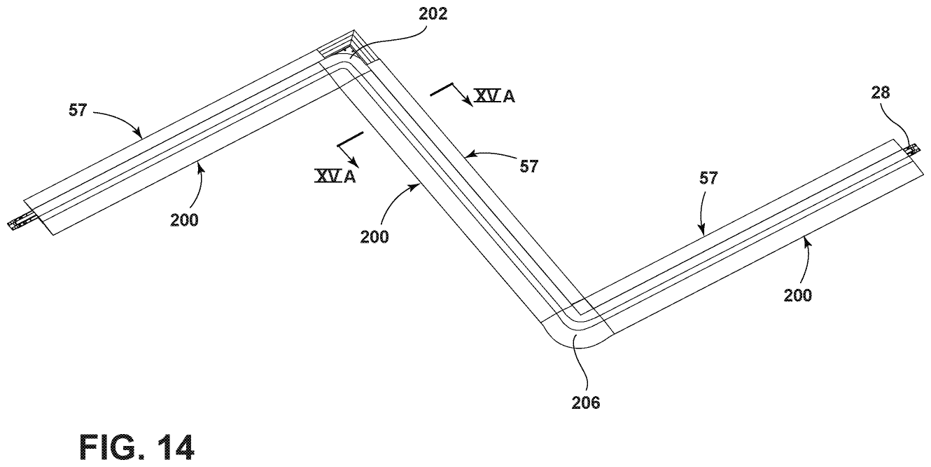

The wire routing system 10 (FIG. 13) may alternatively or further include a plurality of ramps 200, inner corner ramp members 202 and outer corner ramp members 206, each configured for the routing of low voltage communication lines there through such as CAT5, CAT6, fiber optic, and the like, and allowing for variously configured overall layouts (FIGS. 13 and 14).

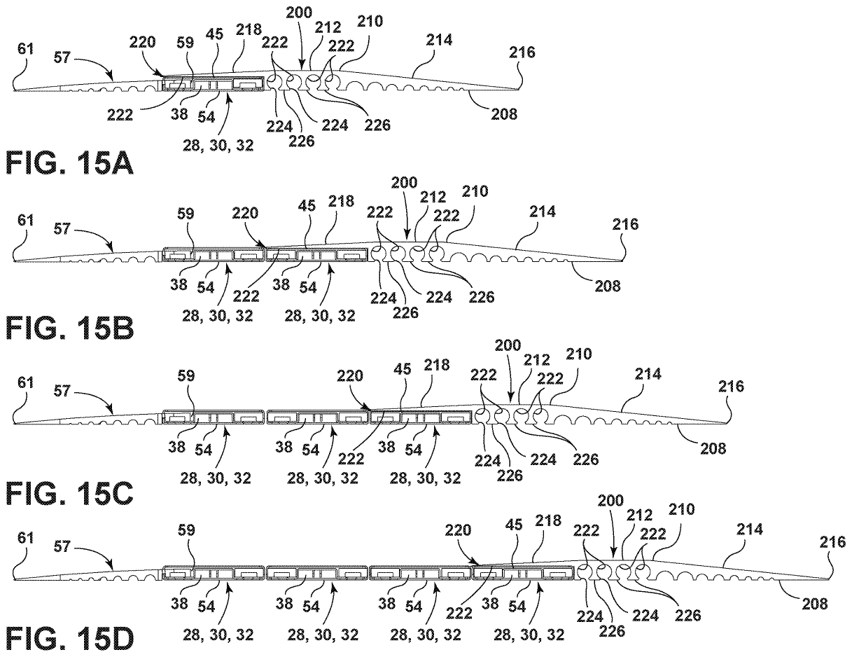

Each ramp 200 (FIGS. 15A-15D) may be configured to extend along sides of the tracks 28, 30, 32, and may have a height that is greater than the height of the tracks 28, 30, 32, and may be at least partially supported by the tracks 28, 30, 32 such that an underside or bottom surface 208 of the ramps 200 is coplanar with the bottom surface 54 of the lower portion 36 of the tracks 28, 30, 32. The upper surface 210 may include a central surface 212 that is substantially parallel with the supporting floor surface 26, a first tapered surface 214 that tapers when moving from the central surface 212 toward an outboard or distal edge 216, and a second tapered surface 218 that tapers when moving from the central surface 212 toward an inboard or proximate edge 220, where the tapered surfaces 214, 218 enable the ramp 200 to be less apparent when placed under a floor covering such as a carpet, and cooperate to reduce the chances of tripping and to facilitate the movement of furniture over the assembly. In the illustrated example, each ramp 200 may be secured to the track 28, 30, 32 via an adhesive located between a downwardly facing surface 222 of the ramp 200 and the upper surface 45 of the upper portion 34 of the track 28, 30, 32. Alternatively, the ramp 200 may be secured or attached to the track 28, 30, 32 via separated mechanical fasteners, integrated snap engagements, and the like.

Each ramp 200 may include one or more longitudinally extending channels 222 configured for the routing of low voltage communication lines therealong. In the illustrated example, each channel 222 is accessed via a relatively narrowed opening 224 thereby providing for a snap-fit receiving of the wires therein allowing for prewiring of the ramps 200 prior to attaching the ramps 200 to the tracks 28, 30, 32 and/or prior to final installation of the system 10 within the given floor plan area. The narrowed openings 224 are at least partially defined by longitudinally. extending feet 226 spaced between the channels 222 where the feet 226 are configured to abut the floor surface 26 and support the ramp 200 therefrom and prevent deformation of the ramp 200 and channels 222 when a force is exerted to the surfaces 212, 214, 218, thereby protecting wires located within the channel 222 from damage. It is noted that the configuration of the ramp 200 may allow the ramp 200 to extend to a height above the floor surface 26 greater than that of the track 28, 30, 32, thereby allowing the channels 222 to have a greater height or diameter than the wire routing channel 38 of the tracks 28, 30, 32 for the routing of comparatively larger low voltage communication lines therethrough.

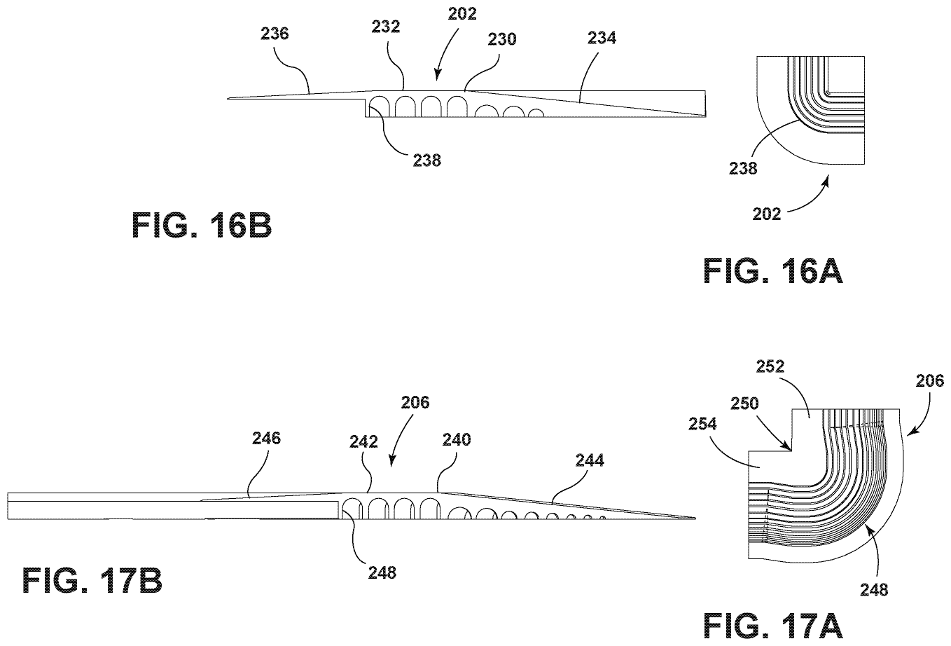

Each inner corner ramp member 202 (FIGS. 16A, 16B) includes an upper surface 230 that includes a central surface 232, a first tapered surface 234, and a second tapered surface 236, corresponding respectively to and substantially flush with the central surface 212, the first tapered surface 214, and the second tapered surface 218 of the ramp 200. Each inner corner ramp member 202 further includes channels 238 substantially aligned with the corresponding channels 222 of the ramps 200. In the illustrated example the channels 238 are curved at a constant radius for each given channel 236.

Each outer corner ramp member 206 (FIGS. 17A, 17B) includes an upper surface 240 that includes a central surface. 242, a first tapered surface 244, and a second tapered surface 236, corresponding respective to and substantially flush with the central surface 212, the first tapered surface 214, and the second tapered surface 218 of the ramp. 200. Each outer corner ramp member 204 further includes channels 248 substantially aligned with the corresponding channels 222 of the ramps. 200. In the illustrated examples, the channels 248 are curved at various inwardly or outwardly curved radii for each given channel 248. The curvature of the channels 238 of the inner corner ramp member 202 and of the channels 248 of the outer corner ramp member 206 and sized and configured to maintain a minimum bend radius to maintain the data capacity integrity of the low voltage data communication lines routed therethrough.

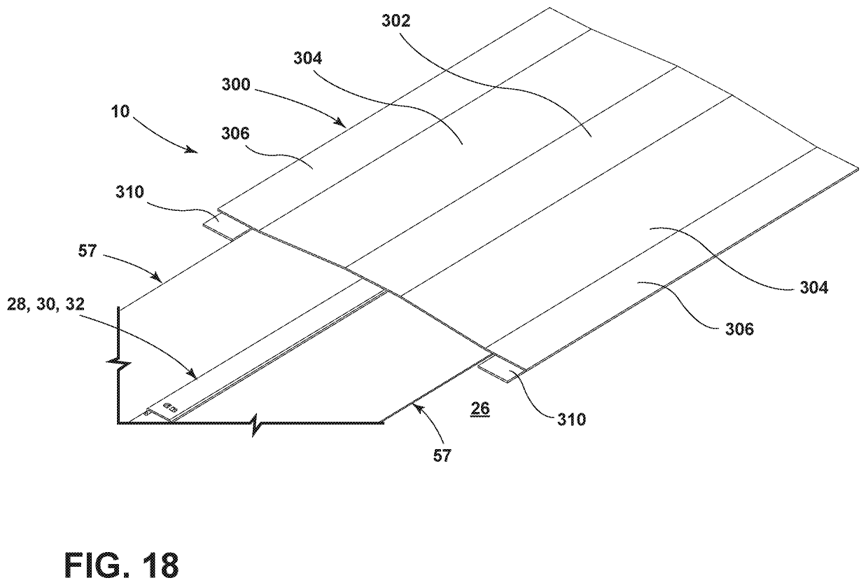

The wire routing system 10 (FIG. 18) may further or alternatively include a cover member 300 that extends over and along a majority of the track 28, 30, 32 and ramp member 57 assemblies. In the illustrated example, the cover member 300 includes an inner flat portion 302 that aligns with and covers the track or tracks 28, 30, 32, a pair of angled portions 304 sloping downwardly from opposite sides of the flat portion 302 and which align with and cover the ramp members 57, and a pair of flat outer portions 306 extending outwardly from corresponding angled portions 304 such that the outer portions 306 are configured to be substantially parallel the floor surface 26. The cover member 300 may be secured to the floor surface 26 by an adhesive tape 310 between the outer portions 306 and the floor surface 26. The cover member 300 may comprise metal or hard plastic. The cover member 300 is configured to adapt the wire routing system 10 for applications that do not include covering the wire routing system 10 with a floor covering such as carpet and the like.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A wire routing system, comprising:
a plurality of housings each having a raceway extending therethrough, the plurality of housings including an end housing and a middle housing;
a continuous, unbroken wire extending through the raceway of each of the housings of the plurality of housings;
wherein the middle housing includes a connector configured to connect the wire to the middle housing thereby preventing the middle housing from sliding along a length of the wire and electrically grounding the middle housing to the wire;
wherein the end housing is slidable along the length of the wire and has an end configured to be cut to a predetermined length; and
at least one connector plate positioned between the middle housing and the end housing and configured to electrically ground the end housing to the wire via the middle housing.

2. The wire routing system of claim 1, wherein the end housing includes a pair of end housings, and wherein the middle housing is positioned between the pair of end housings along the length of the wire.

3. The wire routing system of claim 1, wherein connection of the middle housing to the end housing by the at least one connector plate prevents the end housing from sliding along the length of the wire.

4. The wire routing system of claim 1, wherein the at least one connector plate is configured to connect the middle housing and the end housing to one another such that the middle housing and the end housing are orthogonally aligned with one another.

5. The wire routing system of claim 1, wherein the at least one connector plate is configured to connect the middle housing and the end housing to one another such that the middle housing and the end housing are longitudinally aligned with one another.

6. The wire routing system of claim 1, wherein the connector includes a crimping member.

7. The wire routing system of claim 1, further comprising:
a ramp member extending longitudinally along and coupled to the at least one of the housings of the interconnected housings, the ramp tapering away from the at least one housing, and including at least one longitudinally extending channel configured to receive at least one low voltage wire therein.

8. The wire routing system of claim 7, wherein the ramp is one of a pair of ramps juxtaposed from one another across the at least one housing.

9. A method for installing a wire routing system, comprising:
providing a wire routing system that includes at least three interconnected housings including a middle housing, an end housing and an additional housing, each housing of the at least three housings including a raceway;
routing a wire through the raceway of each housing of the at least three interconnected housings;
fastening the wire to the middle housing thereby preventing the middle housing from sliding along a length of the wire, wherein the end housing is slidable along the length of the wire;
securing the end housing and the additional housing to the middle housing via a plurality of connector plates thereby electrically grounding the end housing and the additional housing to the wire via the plurality of connector plates; and
securing at least one of the house aides to a structural component of the building.

10. The method of claim 9, wherein the middle housing is secured to the structural component of the building.

11. The method of claim 9, wherein the at least one of the housings is secured to a structural component of the building prior to securing the end housing and the additional housing to the middle housing.

12. The method of claim 9, wherein all of the housings are secured to the structural component of the building.

13. The method of claim 9, wherein securing the end housing and the additional housing to the middle housing via the plurality of connector plates prevents the end housing and the additional housing from sliding along the length of the wire.

14. The method of claim 9, wherein the wire is continuous and unbroken along the length thereof.

15. The method of claim 9, further comprising:
sliding the end housing along the length of the wire until an end of the end housing extends beyond an end of the wire;
cutting the end housing to a preselected length; and
sliding the end housing along the length of the wire until the end of the wire extends beyond the end of the end housing.

16. The method of claim 9, further comprising:
providing a ramp member that tapers across a width thereof and includes a longitudinally extending channel configured to route a low voltage wire therealong;
coupling the ramp member to at least one of the housings such that the ramp extends longitudinally along the at least one housing.

17. A wire routing system, comprising:
a plurality of housings each including a first end, a second end opposite the first end, a raceway extending between the first and second ends, and a longitudinal axis, wherein the plurality of housings includes a first end housing, a second end housing and a middle housing positioned between the first and second end housings;
an electrical wire extending within the raceway and from the first and second ends of each of the plurality of housings, wherein the middle housing is fixed along a length of the electrical wire, and wherein the longitudinal axis of the housings are repositionable with respect to one another; and
a plurality of connector plates configured to secure pairings of adjacent housings of the plurality of housings to one another thereby preventing repositioning of the longitudinal axis of the housings with respect to one another.

18. The wire routing system of claim 17, wherein the middle housing is one of a plurality of middle housings.

19. The wire routing system of claim 17, wherein at least one connector plate of the plurality of connector plates is configured to fix the longitudinal axes of an adjacent pairing of the housings to be substantially orthogonal to one another.

20. The wire routing system of claim 17, wherein at least one connector plate of the plurality of connector plates is configured to fix the longitudinal axes of an adjacent pairing of the housings to be substantially aligned with one another.

21. The wire routing system of claim 17, further comprising:
a ramp member extending longitudinally along and coupled to the at least one of the housings of the interconnected housings, the ramp tapering away from the at least one housing, and including at least one longitudinally extending channel configured to receive at least one low voltage wire therein.
